(19) United States
(12) Patent Application Publication
(10) Pub. No.: US 2026/0351064 A1
(43) Pub. Date: Nov. 5, 2026

(54) Touchless Vending System with Sequential Payment Authentication and Gesture-Based Product Selection

(71) Applicant: Matthew Aaron Pfaltzgraf, Atlanta, GA (US)

(72) Inventor: Matthew Aaron Pfaltzgraf, Atlanta, GA (US)

(21) Appl. No.: 19/195,757

(22) Filed: May 1, 2025

(51) Int. Cl. G07F 9/00; G06F 3/01; G06Q 20/18; G06Q 20/20; G06Q 20/32; G06Q 30/0601

(52) U.S. Cl. CPC G07F 9/009; G06F 3/017; G06Q 20/18; G06Q 20/202; G06Q 20/3278; G06Q 30/0641

(57) ABSTRACT

A touchless vending system is provided comprising a housing configured to store a plurality of products, a payment authentication module comprising a contactless payment reader, a gesture recognition system comprising an array of proximity sensors positioned adjacent a product selection area, and a controller operably coupled to the payment authentication module and the gesture recognition system. The controller maintains the gesture recognition system in an inactive state prior to successful processing of a payment transaction, activates the gesture recognition system upon successful payment processing, receives gesture input data, determines a selected product based on the gesture input data, and operates a product dispensing mechanism to release the selected product. A feedback system provides a visual indication corresponding to system operation. The touchless vending system enables contactless transactions through sequential payment authentication and gesture-based product selection without requiring physical contact with shared surfaces.

### CROSS-REFERENCE TO RELATED APPLICATIONS

This application claims the benefit of priority under 35 U.S.C. § 119(e) to U.S. Provisional Patent Application No. 63/784,183, filed on Apr. 6, 2025, the entire contents of which are incorporated herein by reference.

### FIELD OF INVENTION

The present invention relates generally to vending machines and automated retail systems, and more particularly to touchless vending systems employing contactless payment authentication and gesture-based product selection.

### BACKGROUND

Automated retail environments have long relied on vending machines to facilitate the purchase and dispensing of products in a self-service format. Traditional vending systems, however, generally require users to interact physically with various mechanical interfaces, including buttons, keypads, coin slots, and touchscreens. These interaction points introduce significant friction into the purchasing process, necessitating multi-step selections and manual payment actions. Moreover, the mechanical components inherent to such machines are susceptible to wear, vandalism, and mechanical failure, resulting in increased maintenance costs and operational downtime. As user expectations shift toward seamless, efficient transactions, conventional vending solutions have struggled to keep pace, often appearing outdated and cumbersome in comparison to modern digital retail experiences.

The heightened awareness of public hygiene risks, particularly following global health events such as the COVID-19 pandemic, has further underscored the drawbacks of traditional vending machine designs. High-touch surfaces commonly found on vending units represent potential transmission vectors for pathogens, creating user hesitancy and diminishing transaction volumes in sensitive environments such as healthcare facilities, transportation hubs, educational institutions, and hospitality venues. Although some modern vending machines have incorporated contactless payment options, these improvements often address only one stage of the vending interaction while leaving the product selection phase reliant on physical touch, thereby failing to eliminate the underlying hygiene concerns.

Attempts to advance touchless vending interactions have introduced various alternative technologies, such as mobile applications that allow users to select and pay for products remotely. While effective in certain contexts, such solutions impose their own barriers to adoption. Mobile app-based systems typically require users to download specific applications, create accounts, provide personal information, and maintain a reliable internet connection throughout the transaction. These requirements introduce new layers of complexity and exclude users who may lack compatible devices, technical proficiency, or willingness to engage in app ecosystems. Consequently, while nominally touchless, such approaches fail to offer the universal accessibility and spontaneity critical to high-traffic, public-facing vending deployments.

The closest known prior art, exemplified by disclosures such as US2022172549A1, describes vending systems that incorporate gesture-based product selection combined with NFC payment authentication. However, these systems suffer from significant limitations. Most notably, existing designs often allow product selection to occur before successful payment authentication, creating potential vulnerabilities in transaction security and user accountability. Additionally, gesture detection in such prior systems is commonly based on generalized proximity sensors or camera-based systems, which may lack precision, suffer from environmental sensitivity, and increase system complexity and cost. Furthermore, these prior approaches tend to blend selection and payment into a single process without enforcing a clearly gated transaction sequence, thereby limiting reliability in secure, unattended vending contexts.

Accordingly, there remains a need in the field of automated retail for an improved vending system that fully eliminates physical touchpoints during both payment and product selection stages, enhances transactional integrity through a clearly structured sequence of operations, and offers an intuitive, device-free user experience accessible to the broadest range of consumers without requiring additional applications or specialized hardware. In addition, a robust solution should optimize system reliability, minimize maintenance requirements, and enable rapid, hygienic transactions adaptable to a wide variety of deployment environments.

It is within this context that the present invention is provided.

### SUMMARY

The present invention relates to a touchless vending system configured to enable secure, contactless transactions through sequential payment authentication and gesture-based product selection. The system includes a housing configured to store a plurality of products, a payment authentication module comprising a contactless payment reader configured to detect a payment device and process a payment transaction, and a gesture recognition system comprising an array of proximity sensors positioned adjacent a product selection area. A controller is operably coupled to the payment authentication module and the gesture recognition system, and is configured to maintain the gesture recognition system in an inactive state prior to successful payment processing, activate the gesture recognition system upon successful payment processing, receive gesture input data thereafter, determine a selected product based on the gesture input data, and operate a product dispensing mechanism associated with the selected product. A feedback system provides visual indications corresponding to operation of the touchless vending system.

The sequential activation of the gesture recognition system only upon successful payment authentication enhances transactional security, ensures intuitive user interaction, and maintains a hygienic interface free from shared physical touchpoints. The system provides a reliable and efficient platform suitable for a wide variety of deployment environments, including healthcare facilities, transportation hubs, educational institutions, workplaces, and public spaces.

In some embodiments, the proximity sensors of the gesture recognition system comprise infrared emitters and photodiodes. The use of infrared technology enables reliable detection of hand gestures in varying lighting conditions while maintaining low power consumption.

In further embodiments, the proximity sensors of the gesture recognition system comprise capacitive field sensors. Capacitive sensing provides robust hand detection capability while offering potential immunity to optical interference from ambient light sources.

In some embodiments, the payment authentication module communicates with the payment device using protocols such as Near Field Communication (NFC) or Radio-Frequency Identification (RFID). These communication methods ensure compatibility with widely available consumer devices while maintaining secure payment standards.

In further embodiments, the controller is configured to disable the gesture recognition system after a predetermined timeout period following activation if no product selection is detected. This automatic deactivation preserves system energy and prevents unintended operation.

In some embodiments, the feedback system comprises a plurality of light-emitting diodes (LEDs) positioned to correspond visually to the plurality of products. Visual tracking through LED indicators provides users with intuitive, real-time feedback during the selection process.

In further embodiments, the light-emitting diodes are configured to indicate at least one of a standby state, an active selection state, or a product selection confirmation. Clear visual states assist users in understanding the transaction flow without the need for textual prompts.

In some embodiments, the feedback system further comprises an audio output device configured to generate audible signals corresponding to payment authentication, product selection, or product dispensing. Audible feedback enhances system accessibility for visually impaired users and improves overall user experience.

In further embodiments, each product dispensing mechanism comprises a solenoid actuator configured to release an associated product upon activation. Solenoid-based dispensing systems offer a compact and reliable method for releasing products with minimal moving parts.

In yet further embodiments, each product dispensing mechanism comprises a motorized release mechanism configured to convey the selected product to a collection area. Motorized delivery mechanisms facilitate the handling of larger or irregularly shaped products.

In some embodiments, the touchless vending system further comprises a wireless communication module operably coupled to the controller and configured to transmit transaction data or inventory data to a remote system. Wireless connectivity enables remote monitoring, fleet management, and real-time inventory tracking.

In further embodiments, the wireless communication module is configured for communication over at least one of a Wi-Fi network, a cellular network, or a Bluetooth network. Multiple communication options allow system adaptability to different infrastructure conditions.

In some embodiments, the housing comprises a translucent or transparent front panel positioned adjacent the gesture recognition system. This arrangement protects the sensor array while allowing accurate gesture detection through the panel.

In further embodiments, the controller is configured to track multiple gesture inputs during a time window following payment authentication and to initiate dispensing of multiple products based on the tracked inputs. Multi-selection capability supports bundle sales and improves transaction efficiency.

In some embodiments, the controller is configured to provide visual tracking of hand movement across the product selection area by dynamically illuminating corresponding portions of the feedback system. Dynamic lighting guidance enhances user confidence during the selection process.

In further embodiments, the payment authentication module comprises an antenna configured to detect payment devices within a range of approximately 2 to 10 centimeters from the surface of the housing. A limited detection range minimizes unintentional payment triggering and ensures deliberate user interaction.

In some embodiments, the gesture recognition system is configured to detect hand movement within a sensing range of approximately 10 to 30 centimeters from the surface of the housing. Appropriate sensing range improves responsiveness while preventing false detections from distant objects.

In further embodiments, the controller is configured to perform real-time filtering and normalization of gesture input data received from the gesture recognition system. Signal conditioning ensures accurate gesture tracking under variable environmental conditions.

In further embodiments, the housing is configured to be mounted on a wall, a freestanding support, or a kiosk structure. Flexible installation options enable adaptation of the touchless vending system to a wide range of physical environments.

According to another aspect of the invention, the vending system may be configured such that product selection via gesture input occurs prior to payment authentication. In these embodiments, the gesture recognition system remains active during the system's idle state, enabling the detection of user hand movements or proximity gestures corresponding to a specific product location. Upon detecting a valid gesture input, the system registers the selection and transitions to a payment-ready state, during which a payment device may be presented for authentication.

In further embodiments, the system is configured to activate the payment authentication module only in response to a detected gesture, thereby reducing unnecessary transaction polling and focusing payment detection on users who have initiated interaction. Following successful authentication of the presented payment device, the system dispenses the product associated with the previously recorded gesture input. These embodiments provide an alternative interaction model wherein user engagement is initiated through product selection, and are included within the scope of the present invention.

### BRIEF DESCRIPTION OF THE DRAWINGS

Various embodiments of the invention are disclosed in the following detailed description and accompanying drawings.

FIG. 1 illustrates an example block diagram of a touchless vending system showing major system components and their interconnections.

FIG. 2 illustrates an example operational flow diagram of the touchless vending system depicting the sequence from payment authentication through product dispensing.

FIG. 3 illustrates an example front panel layout of the touchless vending system showing the arrangement of the payment zone, gesture sensing area, product display zones, and collection area.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The term “payment authentication module” refers to any hardware or combination of hardware and software configured to securely detect and process payment information from a payment device. This includes, but is not limited to, Near Field Communication (NFC) readers, Radio-Frequency Identification (RFID) readers, and any associated secure payment processing circuits. In one example implementation, the payment authentication module may comprise an NFC antenna tuned to a frequency of approximately 13.56 MHz, integrated with a microcontroller configured to execute encrypted transaction protocols compliant with EMV standards.

The term “gesture recognition system” refers to any arrangement of sensors, emitters, detectors, and processing components configured to detect, track, or interpret hand movements or proximity interactions as user input. This includes, but is not limited to, infrared emitter-photodiode arrays, capacitive field sensors, ultrasonic proximity detectors, and microwave motion sensors. In one example implementation, the gesture recognition system may comprise an array of infrared emitters operating at a wavelength of approximately 850 nanometers, paired with corresponding photodiodes, sampled at a frequency of approximately 75 Hz, and mounted behind a translucent acrylic panel.

The term “controller” refers to any processing unit, microcontroller, microprocessor, application-specific integrated circuit (ASIC), field-programmable gate array (FPGA), or system-on-chip (SoC) configured to manage operation of the vending system components. This includes executing logic for payment processing, gesture input recognition, feedback control, and actuation of dispensing mechanisms. In one example implementation, the controller may be a 32-bit ARM Cortex-M 4 processor operating at a clock speed of approximately 120 MHz, coupled to non-volatile memory for firmware storage and volatile memory for real-time sensor data processing.

The term “proximity sensors” refers to any sensing devices capable of detecting the presence or movement of an object, such as a user's hand, within a defined spatial range without requiring direct physical contact. This includes, but is not limited to, infrared sensors, capacitive plates, ultrasonic transducers, and radar-based systems. In one example implementation, the proximity sensors may be arranged in a two-dimensional matrix layout behind a translucent polycarbonate front panel, configured to detect hand gestures at distances ranging from approximately 10 to 30 centimeters from the panel surface.

The term “feedback system” refers to any hardware components configured to provide sensory output to a user, including but not limited to visual, audible, or haptic signals. In one example implementation, the feedback system may comprise addressable RGB LEDs positioned adjacent each product storage location, programmed to emit different colors or pulsing patterns corresponding to transaction states. In another example, the feedback system may include a piezoelectric speaker embedded within the housing, capable of generating audible tones or voice prompts to guide users through payment and selection operations.

The term “product dispensing mechanism” refers to any mechanical, electromechanical, or fluidic assembly configured to selectively release a product from a storage position into a user-accessible area upon receiving a control signal. This includes, but is not limited to, solenoid-actuated pin releases, motor-driven conveyor belts, servo-controlled arms, gravity-fed chutes, and pneumatic ejection systems. In one example implementation, the product dispensing mechanism may include a latching solenoid actuator connected to a stainless steel retention pin, which retracts when energized to allow the product to fall under gravity into a collection compartment.

The term “housing” refers to any structural enclosure configured to physically support, organize, and protect the internal components of the vending system, including payment modules, sensors, product storage areas, dispensing mechanisms, controllers, and power supplies. In one example implementation, the housing may be constructed from powder-coated sheet metal for durability and corrosion resistance, with front panels formed from impact-resistant polycarbonate or acrylic materials to allow unobstructed operation of proximity sensors while maintaining a clean exterior aesthetic.

The term “payment device” refers to any device capable of transmitting payment information to the payment authentication module without direct physical contact. This includes, but is not limited to, contactless credit cards, debit cards, mobile phones with NFC capability, smartwatches, wristbands, and other wearable payment technologies. In one example implementation, the payment device may be a smartphone configured with a secure element that stores encrypted payment credentials for communication over a contactless channel initiated by proximity to the NFC reader.

The term “wireless communication module” refers to any integrated transceiver or communication assembly configured to transmit and/or receive data wirelessly between the vending system and external systems or networks. This includes, but is not limited to, Wi-Fi modules operating in accordance with IEEE 802.11 standards, cellular communication modules compatible with LTE or 5G networks, and Bluetooth or Bluetooth Low Energy (BLE) modules. In one example implementation, the wireless communication module may comprise a cellular modem configured with a secure virtual private network (VPN) connection for transmitting transaction records and inventory data to a remote management platform.

The term “collection area” refers to any defined region of the housing accessible to a user for retrieving dispensed products. In one example implementation, the collection area may comprise a recessed cavity at the base of the vending system, equipped with a soft lining made of thermoplastic elastomer (TPE) to cushion products upon landing and minimize damage.

### DESCRIPTION OF DRAWINGS

The present invention provides a touchless vending system that addresses long-standing challenges associated with traditional vending machines and prior attempts at touchless interaction. In particular, the system overcomes the hygiene concerns, transactional inefficiencies, and user accessibility barriers inherent in conventional designs that require physical contact with mechanical interfaces or reliance on external mobile applications. By integrating a sequential two-step operation-requiring secure contactless payment authentication prior to enabling gesture-based product selection-the invention ensures improved transactional integrity, system reliability, and intuitive user engagement without the need for physical touch or intermediary devices.

Conventional vending machines typically suffer from mechanical wear and exposure to environmental contaminants due to the necessity of physical touch during both selection and payment stages. Even more recent systems that attempt to enable touchless interactions often permit product selection prior to payment confirmation or rely heavily on mobile device interfaces, thereby introducing security vulnerabilities, usability limitations, and technological barriers for certain users. The present invention directly addresses these deficiencies by creating a fully integrated, self-contained vending platform wherein product selection functionality is electronically gated behind successful payment authentication, thereby minimizing the opportunity for fraudulent, incomplete, or accidental transactions.

The system architecture integrates a payment authentication module comprising a contactless payment reader operably coupled to a gesture recognition system formed by an array of proximity sensors. A central controller governs the operation of these components, maintaining the gesture recognition system in an inactive state until a valid payment transaction has been detected and confirmed. Upon activation, the gesture recognition system enables a user to select a desired product through simple, intuitive hand movements, which are interpreted by the controller to initiate dispensing via an associated dispensing mechanism. Throughout the interaction, a feedback system provides real-time visual or audible cues to guide the user through the transaction process without requiring physical contact.

By eliminating dependence on high-touch surfaces and external mobile applications, and by ensuring clear transactional sequencing between payment and selection stages, the invention delivers a vending system that is secure, hygienic, accessible, and operationally efficient. This configuration is particularly well-suited to public environments where reliability, rapid user throughput, and minimized maintenance demands are critical. In the following description, reference is made to various exemplary embodiments and configurations, which are intended to illustrate, but not to limit, the scope of the invention as defined by the appended claims.

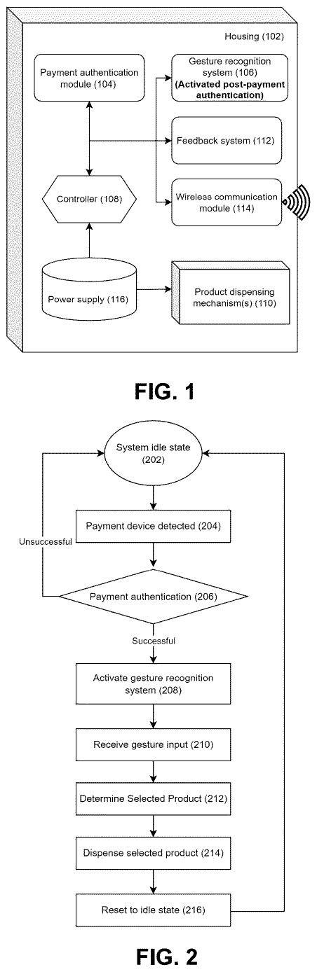

Referring now to the drawings, FIG. 1 illustrates a block diagram of an exemplary touchless vending system 100. The system 100 includes a housing 102 configured to contain and support various system components. The housing 102 may be implemented as a wall-mounted unit, a pedestal-mounted structure, or a freestanding kiosk, and may be fabricated from materials such as powder-coated steel, aluminum, or impact-resistant polymers, with a preferred housing depth of approximately 6 inches to balance structural compactness with internal component accommodation.

The system 100 includes a payment authentication module 104 operably positioned within the housing 102. The payment authentication module 104 may comprise an NFC reader, an RFID reader, or a combination thereof, capable of communicating with payment devices such as contactless credit cards, smartphones, smartwatches, and other wearable payment technologies. The NFC reader may operate at a frequency of approximately 13.56 MHz and may be mounted behind a translucent or transparent panel to allow proximity interaction while protecting the reader from environmental exposure.

Operably coupled to the payment authentication module 104 is a controller 108, which may be implemented using a 32-bit ARM Cortex-M series microcontroller or equivalent embedded processor. The controller 108 manages overall system operation, including receiving payment authentication signals, controlling activation of the gesture recognition system 106, processing gesture input, executing dispensing operations, and managing feedback systems. The controller 108 may include secure memory partitions, real-time operating firmware, and interfaces compatible with common communication protocols such as SPI, I²C, and UART.

Also connected to the controller 108 is the gesture recognition system 106, which may include an array of infrared emitters and photodiodes, capacitive proximity sensors, ultrasonic sensors, or other proximity-detection technologies. In an exemplary implementation, the gesture recognition system 106 is arranged behind a smoked acrylic panel and sampled at a frequency of approximately 50 to 100 Hz to enable accurate, real-time hand gesture tracking. In preferred embodiments, the gesture recognition system 106 remains inactive during idle operation and is selectively activated by the controller 108 following successful payment authentication.

The controller 108 is further operably coupled to one or more product dispensing mechanisms 110, each configured to release a product into a user-accessible collection area. The product dispensing mechanisms 110 may include solenoid-driven pin releases, motorized conveyor systems, rotating carousels, or pneumatic ejectors. In a preferred embodiment, the dispensing mechanism 110 includes a solenoid actuator configured to retract a retention pin, allowing the selected product to fall by gravity into a collection bay.

The system 100 also includes a feedback system 112, operably connected to the controller 108. The feedback system 112 may comprise an array of addressable RGB LEDs, a piezoelectric speaker, or a combination thereof. The feedback system 112 provides dynamic visual and/or audible indicators corresponding to system states, including idle, payment detection, payment success, gesture recognition activation, and product dispensing in progress. Different colors, flashing patterns, or sound cues may be employed to guide the user through the interaction sequence.

In some embodiments, the system 100 further includes a wireless communication module 114 configured for Wi-Fi, LTE, or Bluetooth connectivity. The wireless communication module 114 enables remote monitoring, inventory management, transaction logging, firmware updates, and diagnostic reporting. Secure communication protocols such as HTTPS or MQTT over VPNs may be utilized to maintain data security. A power supply 116 is operably connected to provide regulated voltages to the system components. In exemplary implementations, the power supply 116 may draw from standard mains electricity, although alternative embodiments may incorporate rechargeable lithium-ion battery packs with integrated battery management systems to allow mobile or off-grid deployment.

FIG. 2 illustrates an operational flow diagram of the touchless vending system 200. The process begins with the system in an idle state 202, wherein the gesture recognition system 106 is inactive to conserve energy and prevent unintentional gesture detections. During this idle state 202, the feedback system 112 may provide subtle illumination or pulsing light patterns to indicate system readiness.

When a payment device is detected in proximity to the payment authentication module 104, the system transitions to a payment device detected state 204. Detection may occur via NFC or RFID communication protocols, and the detection field may be tuned to a proximity range of approximately 2 to 10 centimeters to ensure deliberate user interaction.

Upon detection of a payment device, the system proceeds to a payment authentication decision stage 206. The controller 108 determines whether the payment transaction has been successfully authenticated. If the payment authentication is unsuccessful, the system returns immediately to the idle state 202 without activating the gesture recognition system 106. If the payment authentication is successful, the system activates the gesture recognition system at stage 208, energizing the sensor array and signaling the activation to the user through the feedback system 112, such as by changing LED illumination patterns or emitting an audio chime.

With the gesture recognition system 106 active, the user's hand gestures are detected in the receive gesture input stage 210. The system may interpret hand movement, proximity, or hovering gestures across a predefined selection matrix, using reflected infrared light intensity or capacitive field disturbances to determine user intent. Real-time feedback is provided to the user as gestures are detected, guiding them toward accurate product selection.

Following successful gesture detection, the system proceeds to determine the selected product at stage 212 by mapping the detected gesture coordinates to a specific product identifier stored in the controller's memory. The controller 108 then commands the appropriate product dispensing mechanism 110 to dispense the selected product in stage 214.

After successful dispensing, the system resets to the idle state 216, deactivating the gesture recognition system 106 and preparing for the next user interaction. In some embodiments, a timeout mechanism may be employed such that if no valid gesture input is received within a predefined period following payment authentication, the system automatically reverts to the idle state to conserve power and maintain security.

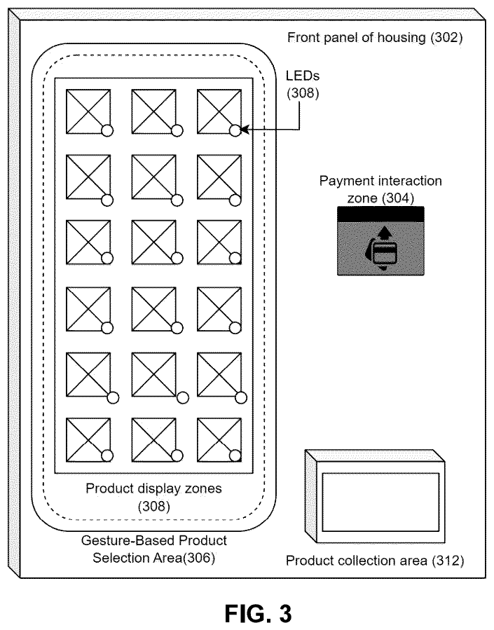

FIG. 3 illustrates a front panel functional layout of the touchless vending system 300. A front panel 302 is depicted, which may be formed from impact-resistant materials such as acrylic, polycarbonate, or tempered glass to protect internal components while enabling optical transmission necessary for proximity sensor operation.

A payment interaction zone 304 is positioned on the front panel 302. The payment interaction zone 304 corresponds to the embedded location of the payment authentication module 104 and is visually highlighted to direct user attention. The zone 304 may incorporate printed icons, illuminated borders, surface textures, or other visual indicators to guide users where to present their payment devices.

Positioned adjacent to the payment interaction zone 304 is a gesture sensing zone 306. The gesture sensing zone 306 aligns with the location of the gesture recognition system 106 and provides a surface under which user hand movements are detected for product selection. In exemplary embodiments, the gesture sensing zone 306 may be visually distinct from the payment interaction zone 304 through contrasting graphics or lighted boundaries.

A series of product display zones 308 are positioned across the front panel 302. Each product display zone 308 corresponds to a product offered for vending and may comprise physical compartments with transparent windows, printed depictions, or backlit representations of the products. The product display zones 308 may be arranged in a linear, grid, or staggered layout to optimize space utilization and user accessibility.

Each product display zone 308 is associated with one or more visual feedback LEDs 310. The LEDs 310 are operably connected to the controller 108 and are programmed to display various states such as availability, selection confirmation, or error indication. The feedback system 112 may employ color changes (e.g., green for active selection, red for unavailable) or dynamic patterns (e.g., pulsing or flashing) to assist users in understanding system status during interactions.

A collection area 312 is provided at the lower portion of the front panel 302. The collection area 312 is configured to receive the dispensed products in a manner that minimizes product damage and facilitates user retrieval. In some embodiments, the collection area 312 may be recessed into the housing and lined with an energy-absorbing material such as thermoplastic elastomer to cushion products as they are dispensed.

It will be understood that the arrangement shown in FIG. 3 is illustrative, and alternative layouts are contemplated. For example, the payment interaction zone 304 may be positioned above or beside the gesture sensing zone 306, and the product display zones 308 may vary in size and placement according to product dimensions and aesthetic preferences. Similarly, the gesture sensing area may be expanded, subdivided, or differently shaped to accommodate specific vending configurations without departing from the inventive concept.

In some embodiments, the vending system may be configured to detect user gesture input prior to initiating payment authentication. In such configurations, the gesture recognition system remains active during the system's idle state, allowing continuous monitoring for user interactions across predefined selection zones. Upon detection of a valid gesture input, the system registers the corresponding product selection and prompts the user to present a payment device at a designated payment interaction area. The payment authentication module is then activated to detect and validate the transaction.

The gesture recognition system in this embodiment may include infrared emitter-photodiode arrays, capacitive proximity sensors, or other motion or proximity sensing technologies arranged to detect hand movement over or near the product selection area. The system may utilize filtering algorithms and gesture validation logic to reduce the likelihood of false detections caused by ambient interference or incidental motion. To manage power consumption, the gesture recognition system may operate in a low-power polling mode or with zonal activation logic to reduce active sensing regions until movement is detected.

Once a gesture is recognized and mapped to a product selection, the system enters a payment-ready state in which the payment authentication module is enabled. The user may then tap or present a contactless payment device, such as an NFC-enabled card, smartphone, or wearable, at the designated reader location. Upon successful authentication, the controller activates the product dispensing mechanism associated with the previously selected product. If the payment is not successfully completed within a predetermined time window, the selection may be cleared and the system reset to idle, optionally with user notification via the feedback system.

This gesture-first model offers an alternative interaction paradigm in which the product selection occurs before payment authentication. While potentially advantageous in terms of perceived user engagement, it may require the gesture sensing components to remain in a ready state for extended periods, potentially increasing power demands and system sensitivity to environmental noise. Nonetheless, this configuration may be preferable in certain deployment scenarios or use cases where immediate product engagement enhances user experience, and is contemplated as a supported variant within the scope of the present disclosure.

### CONTROLLER/PROCESSOR COMPONENTS

A controller as described herein may include any suitable type of computing device configured to manage the operation of the touchless vending system, such as a microcontroller, central processing unit (CPU), system on a chip (SoC), field-programmable gate array (FPGA), or application-specific integrated circuit (ASIC). The controller may operate with one or more cores and is configured to execute the functions associated with payment authentication, gesture recognition activation, gesture input processing, product selection determination, dispensing operation initiation, feedback system control, and optional wireless communication as described herein.

The controller may be operably connected to one or more memory devices, such as random access memory (RAM), read-only memory (ROM), flash storage, or other non-volatile memory components. These memory devices store computer-readable instructions which, when executed by the controller, perform the methods associated with sequential payment and gesture-based selection operation of the vending system. The controller and memory devices may communicate via data buses or other suitable communication pathways such as serial peripheral interface (SPI), inter-integrated circuit (I²C), or universal asynchronous receiver-transmitter (UART) connections.

The controller may further interface with various input/output (I/O) devices associated with the vending system, including but not limited to the payment authentication module, the gesture recognition system, the product dispensing mechanisms, the visual or audio feedback components, and any wireless communication modules. The controller may also include communication interfaces for connecting to wired or wireless networks, facilitating remote system monitoring, inventory reporting, transaction logging, and firmware updating where applicable.

Control logic or executable software instructions may be stored within memory devices and executed by the controller to implement the operational sequences of the system. This logic may be modular in structure, comprising software components, firmware routines, or discrete processing tasks that interact to perform the functions disclosed herein, such as enforcing sequential operation of payment authentication prior to gesture input acceptance.

The described computing operations involve the manipulation of data represented as electrical, optical, or magnetic signals stored within memory or transferred between components of the system. These operations are machine-executed and occur without manual intervention, although they may interface with human operators indirectly through the feedback mechanisms and physical interaction zones provided on the vending system.

The systems and methods disclosed are not limited to any particular hardware configuration, firmware design, or programming language, and may be implemented using a variety of commercially available or custom-designed computing components suitable for vending, transaction processing, and user interface control applications.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the touchless vending system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A touchless vending system comprising:
a housing configured to store a plurality of products;
a payment authentication module positioned on the housing, the payment authentication module comprising a contactless payment reader configured to detect a payment device and process a payment transaction;
a gesture recognition system operably coupled to the payment authentication module, the gesture recognition system comprising an array of proximity sensors positioned adjacent a product selection area of the housing, the gesture recognition system configured to detect spatial movement of a hand of a consumer across the product selection area;
a controller operably coupled to the payment authentication module and the gesture recognition system, the controller configured to:
maintain the gesture recognition system in an inactive state, wherein the array of proximity sensors is not energized, prior to successful processing of a payment transaction;
continue to maintain the gesture recognition system in an inactive state upon unsuccessful processing of a payment transaction;
activate the gesture recognition system by energizing the array of proximity sensors upon successful processing of a payment transaction;
operate the gesture recognition system with zonal activation logic to reduce active sensing regions of the array of proximity sensors until movement of the hand of the consumer is detected within a zone of the product selection area;
receive gesture input data from the gesture recognition system after activation;
determine a selected product based on the gesture input data, wherein the gesture input data comprises spatial position information corresponding to movement of the hand of the consumer relative to the array of proximity sensors, and wherein the selected product is determined based on a correspondence between the spatial position information and a location of the selected product within the product selection area; and
initiate a dispensing operation corresponding to the selected product;
a product dispensing mechanism associated with each of the plurality of products and operably coupled to the controller, wherein the controller is configured to operate the product dispensing mechanism to release the selected product; and
a feedback system operably coupled to the controller and configured to provide a visual indication corresponding to operation of the touchless vending system.

2. The touchless vending system of claim 1, wherein the proximity sensors of the gesture recognition system comprise infrared emitters and photodiodes.

3. The touchless vending system of claim 1, wherein the proximity sensors of the gesture recognition system comprise capacitive field sensors.

4. The touchless vending system of claim 1, wherein the payment authentication module is configured to communicate with the payment device using a protocol selected from the group consisting of Near Field Communication (NFC) and Radio-Frequency Identification (RFID).

5. The touchless vending system of claim 1, wherein the controller is further configured to disable the gesture recognition system after a predetermined timeout period following activation if no product selection is detected.

6. The touchless vending system of claim 1, wherein the feedback system comprises a plurality of light-emitting diodes positioned to correspond to the plurality of products.

7. The touchless vending system of claim 6, wherein the light-emitting diodes are configured to indicate at least one of a standby state, an active selection state, or a product selection confirmation.

8. The touchless vending system of claim 1, wherein the feedback system further comprises an audio output device configured to generate audible signals corresponding to payment authentication, product selection, or product dispensing.

9. The touchless vending system of claim 1, wherein each product dispensing mechanism comprises a solenoid actuator configured to release an associated product upon activation.

10. The touchless vending system of claim 1, wherein each product dispensing mechanism comprises a motorized release mechanism configured to convey the selected product to a collection area.

11. The touchless vending system of claim 1, further comprising a wireless communication module operably coupled to the controller and configured to transmit transaction data or inventory data to a remote system.

12. The touchless vending system of claim 11, wherein the wireless communication module is configured for communication over at least one of a Wi-Fi network, a cellular network, or a Bluetooth network.

13. The touchless vending system of claim 1, wherein the housing comprises a translucent or transparent front panel positioned adjacent the gesture recognition system.

14. The touchless vending system of claim 1, wherein the controller is further configured to track multiple gesture inputs during a time window following payment authentication and to initiate dispensing of multiple products based on the tracked inputs.

15. The touchless vending system of claim 1, wherein the controller is configured to provide visual tracking of hand movement across the product selection area by dynamically illuminating corresponding portions of the feedback system.

16. The touchless vending system of claim 1, wherein the payment authentication module comprises an antenna configured to detect payment devices within a range of approximately 2 to 10 centimeters from the surface of the housing.

17. The touchless vending system of claim 1, wherein the gesture recognition system is configured to detect hand movement within a sensing range of approximately 10 to 30 centimeters from the surface of the housing.

18. The touchless vending system of claim 1, wherein the controller is further configured to perform real-time filtering and normalization of gesture input data received from the gesture recognition system.

19. The touchless vending system of claim 1, wherein the housing is configured to be mounted on a wall, a freestanding support, or a kiosk structure.
